(19) United States
(12) Patent Application Publication
(10) Pub. No.: US 2018/0026786 A1
(43) Pub. Date: Jan. 25, 2018

(54) ENCRYPTION DEVICE, ENCRYPTION METHOD, ENCRYPTION DATA, AND NON-TRANSITORY COMPUTER READABLE STORAGE MEDIUM

(71) Applicant: YAHOO JAPAN CORPORATION, Tokyo (JP)

(72) Inventor: Shinkichi HORIE, Tokyo (JP)

(73) Assignee: YAHOO JAPAN CORPORATION, Tokyo (JP)

(21) Appl. No.: 15/648,859

(22) Filed: Jul. 13, 2017

(30) Foreign Application Priority Data
Jul. 19, 2016 (JP) 2016-141845

(51) Int. Cl. H04L 9/30; H04L 9/06

(52) U.S. Cl. CPC H04L 9/30; H04L 9/0643; H04L 9/0618

(57) ABSTRACT

According to one aspect of an embodiment an encryption device includes an acquisition unit that acquire information that is to be an encryption object. The encryption device includes an encryption unit that apply a plurality of functions to the acquired information in order of having a quasi-periodic structure to encrypt the information.

### CROSS-REFERENCE TO RELATED APPLICATIONS

The present application claims priority to and incorporates by reference the entire contents of Japanese Patent Application No. 2016-141845 filed in Japan on Jul. 19, 2016.

### BACKGROUND OF THE INVENTION

### 1. Field of the Invention

The present invention relates to an encryption device, an encryption method, encryption data, and a non-transitory computer readable storage medium.

### 2. Description of the Related Art

In recent years, information distribution through the Internet is actively performed with exponential popularization of the Internet. In such information distribution, distribution of encrypted information by a common key encryption method or a public key encryption method is performed to ensure security.
Patent Literature 1: U.S. Pat. No. 6,792,108
Non-Patent Literature 1: “Fractal features of electronic transport phenomena in one-dimensional Fibonacci arrays”, Atsushi Nomata, Tokyo University of Science, Doctoral Dissertation, Mar. 20, 2008
Non-Patent Literature 2: “Self-similarity appearance conditions for electronic transmission probability and Landauer resistance in a Fibonacci array of T stubs”, Atsushi Nomata, Shinkichi Horie, PHYSICAL REVIEW B 76, 235113 2007
Non-Patent Literature 3: “Fractal feature of localized electronic states in Fibonacci arrays of Aharonov-Bohm rings”, Atsushi Nomata, Shinkichi Horie, PHYSICAL REVIEW B 75, 115130 2007

However, the conventional technologies may not be able to ensure security.

In recent years, quantum computing technologies using a quantum behavior of a substance have been made progress. When using such a quantum computing technology, an encryption key and a decryption key can be acquired from the encrypted information within a significant time, and thus there is a risk of decryption of the encrypted information by a third party.

### SUMMARY OF THE INVENTION

It is an object of the present invention to at least partially solve the problems in the conventional technology.

According to one aspect of an embodiment an encryption device includes an acquisition unit that acquire information that is to be an encryption object. The encryption device includes an encryption unit that apply a plurality of functions to the acquired information in order of having a quasi-periodic structure to encrypt the information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of encryption processing executed by an encryption device according to an embodiment;

FIG. 2 is a diagram illustrating a configuration example of an encryption device according to an embodiment;

FIG. 3 is a diagram illustrating an example of information registered in a rule table according to an embodiment;

FIGS. 4A and 4B are diagrams illustrating an example of processing in which an encryption device according to an embodiment performs encryption;

FIGS. 5A and 5B are diagrams illustrating variations of a quasi-periodic structure used by an encryption device according to an embodiment;

FIG. 6 is a diagram illustrating an example of a spectrum of a wavenumber of a wave that passes through a self-similar photonic crystal;

FIG. 7 is a diagram illustrating an example of relationship between a transmission probability and a wavenumber.

FIG. 8 is a flowchart illustrating an example of a flow of encryption processing and decryption processing according to an embodiment; and

FIG. 9 is a diagram illustrating an example of a hardware configuration.

### DETAILED DESCRIPTION OF THE PREFERRED EMBODIMENTS

Hereinafter, forms for implementing an encryption device, an encryption method, encryption data, and a non-transitory computer readable storage medium according to the present application (hereinafter, described as “embodiments) will be described in detail with reference to the drawings. Note that the encryption device, the encryption method, the encryption data, and the non-transitory computer readable storage medium according to the present application are not limited by the embodiments. Further, the same portion is denoted with the same sign in the embodiments below, and overlapping description is omitted.

### Embodiments

1-1. Example of Encryption Device

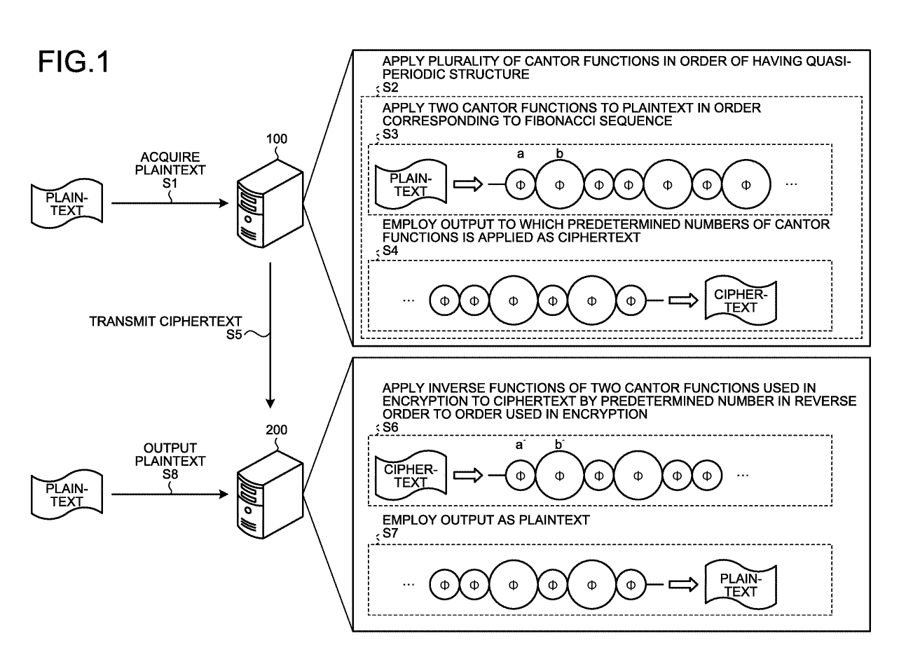

First, an example of encryption processing executed by an encryption device will be described using FIG. 1. FIG. 1 is a diagram illustrating an example of encryption processing executed by an encryption device according to an embodiment. In FIG. 1, an encryption device 100 is an information processing device that executes encryption processing described below, and is realized by a server device, a cloud system, or the like.

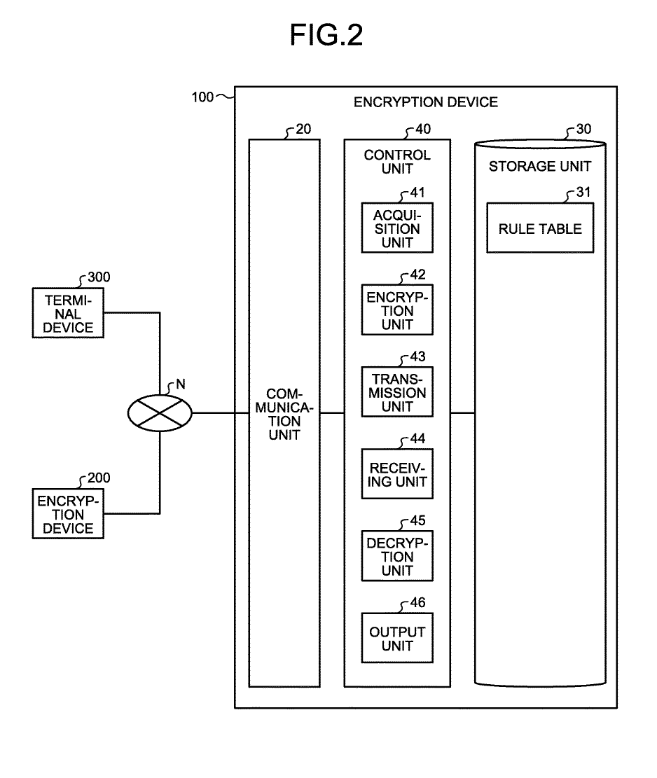

To be specific, the encryption device 100 can communicate with an arbitrary device such as a terminal device 300 (for example, FIG. 2) used by a user through a predetermined network N such as the Internet. Further, the encryption device 100 can communicate with an encryption device 200 having a similar function to the encryption device 100. For example, the encryption device 100 transmits a ciphertext that is an encrypted plaintext to the encryption device 200 by the encryption processing below. In such a case, the encryption device 200 decrypts the ciphertext to the plaintext and provides the decrypted plaintext to the user or the like.

Similarly, the encryption device 200 encrypts a plaintext acquired from the user or the like by encryption processing, and transmits a ciphertext to the encryption device 100. In such a case, the encryption device 100 decrypts the ciphertext to the plaintext, and provides the decrypted plaintext to the user or the like. That is, the encryption devices 100 and 200 are information processing devices that perform encryption and decryption to perform encryption communication.

1-2. Example of Encryption Processing

Here, conventional methods such as a common key encryption method and a public key encryption method may not be able to ensure security. For example, in the conventional encryption methods, a sufficiently large encryption key space is prepared or a question such as factorization that takes time to calculate by a classical computer is used so that the key to be used for the encryption or the decryption cannot be obtained from the ciphertext within a significant time. However, in recent years, quantum computing technologies using a quantum behavior of a substance have been made progress. When using such a quantum computing technology, the encryption key or the decryption key may be able to be acquired from the encrypted information within a significant time.

Therefore, the encryption device 100 executes the following processing. First, the encryption device 100 acquires information to be encrypted, i.e., a plaintext. The encryption device 100 then applies a plurality of functions to the plaintext in order of having a quasi-periodic structure to generate a ciphertext that is an encrypted plaintext. After that, the encryption device 100 transmits the generated ciphertext to the encryption device 200.

In such a case, the encryption device 200 applies inverse functions of the functions used when the encryption device 100 encrypts the plaintext in a reverse order to the order applied to the plaintext by the encryption device 100 to decrypt the ciphertext to the plaintext. Hereinafter, a simple example will be described.

For example, the encryption device 100 applies a predetermined first function and a predetermined second function to the plaintext in order of the first function, the second function, the first function, the first function, and the second function to generate an encrypted sentence. To be specific, the encryption device 100 uses an output of when the plaintext is input to the first function as an input of the second function, an output of the aforementioned second function as an input of the first function, an output of the aforementioned first function as an input of the first function again, an output of the aforementioned first function as an input of the second function, and then obtains an output of the second function as the ciphertext.

Meanwhile, the encryption device 200 holds a first inverse function as an inverse function of the first function and a second inverse function as an inverse function of the second function in advance. The encryption device 200 then applies the second inverse function, the first inverse function, the first inverse function, the second inverse function, and the first inverse function in this order to the ciphertext received from the encryption device 100 to decrypt the ciphertext to the plaintext.

1-3. Quasi-Periodic Structure

Here, the order to apply the plurality of functions by the encryption device 100 will be described. As described above, the encryption device 100 applies the plurality of functions in order of having a quasi-periodic structure. Here, the order of having a quasi-periodic structure refers to a ratio of the numbers of occurrences of A and B converging into an irrational number when A and B are arranged on the basis of a certain rule, that is, the ratio becoming non-periodic. To be specific, quasilattice such as Fibonacci sequence, Penrose tiling, or photonic crystal corresponds thereto.

For example, the encryption device 100 applies the first function and the second function determined in advance in order of the Fibonacci sequence to encrypt the plaintext. To be more specific, the encryption device 100 applies the first function and the second function in order of having a quasi-periodic structure such as the Fibonacci sequence. For example, the encryption device 100 applies the first function and the second function exhibiting a crystal transmittance in a predetermined crystal. As a more conceptual example, the encryption device 100 employs, as the plaintext, a wavenumber of incident light to a crystal in which portions having different transmittances from each other are arranged in order of having a quasi-periodic structure, such as a photonic crystal having a self-similar structure, and employs a wavenumber of transmitted light of the crystal as the ciphertext. That is, the encryption device 100 applies a plurality of functions such as functions exhibiting crystal transmittances in order of having a quasi-periodic structure, thereby to apply a function that configures a function of a Cantor function to the plaintext. Note that the encryption device 100 may apply the first function and the second function that are Cantor functions different from each other.

As a result of such processing, the encryption device 100 can generate cipher for which generation of a key is difficult even using a quantum computer or the like. That is, as described above, when applying the functions in order of having a quasi-periodic structure such as the Fibonacci sequence, an output has a characteristic of non-absolute continuity although the output has continuity, so-called devil's staircase. That is, the encryption device 100 obtains a similar output to an output of when the Cantor function is applied to an input. When the output, i.e., the ciphertext has such a characteristic, cipher attack using differentiation or integration becomes difficult. Note that the encryption device 100 may make the cipher attack using differentiation or integration more difficult by using the Cantor function as a function to be applied.

Further, when using the above-described encryption method, an attacker needs to identify not only the order to apply the first function and the second function but also how many first functions and second functions were applied. Such questions correspond to a question of what structure the portions having different transmittances in a photonic crystal have. A technique to efficiently solve such questions by a classical or quantum calculation technique has not yet been established. Therefore, it can be said that, when the above-described encryption method is used, obtainment of the plaintext by a classical or quantum calculation method from the ciphertext within a significant time is difficult. As a result, the encryption device 100 can improve the robustness of cipher by applying the above-described encryption method.

1-4. Example of Encryption Processing and Decryption Processing

Next, an example of encryption processing executed by the encryption devices 100 and 200 will be described using FIG. 1. For example, the encryption device 100 acquires the plaintext as a transmission object (step S1). In such a case, the encryption device 100 applies a plurality of the Cantor functions to the plaintext in order of having a quasi-periodic structure to encrypt the plaintext (step S2). For example, the encryption device 100 applies a function φa and a function φb as the Cantor functions to the plaintext in order corresponding to the Fibonacci sequence (step S3). To be more specific, the encryption device 100 applies the function φa and the function φb as the Cantor functions to the plaintext in order of the function φa, the function φb, the function φa, the function φa, the function φb, the function φa, the function φb, and the like. The encryption device 100 then employs an output to which a predetermined number of the Cantor functions as the ciphertext (step S4). Note that, in the example illustrated in FIG. 1, the function φa and the function φb are illustrated by the circles called Aharonov-Bohm (AB) ring. To be specific, in the example illustrated in FIG. 1, the function φa is illustrated by the large circle and the function φb is illustrated by the small circle. After that, the encryption device 100 transmits the ciphertext to the encryption device 200 (step S5).

Meanwhile, when receiving the ciphertext, the encryption device 200 applies inverse functions of the Cantor functions used for the encryption by the encryption device 100 by a predetermined number to the ciphertext in reverse order to the order used in the encryption (step S6). For example, when the encryption device 100 applies the Cantor functions in order of the function φa, the function φa, the function φb, the function φa, the function φb, and the function φa, the encryption device 200 applies a function φa⁻ as the inverse function of the function φa and a function φb as the inverse function of the function φb to the ciphertext in order of the function φa⁻, the function φb⁻, the function φa⁻, the function φb⁻, the function φa⁻, and the function φa⁻. The encryption device 200 then employs an output, which is obtained by applying the inverse functions of the Cantor functions to the ciphertext by the predetermined number, as the plaintext (step S7) and outputs the plaintext (step S8), and terminates the processing.

1-5. Rule

Here, when performing encryption communication using the above-described encryption method, the encryption devices 100 and 200 may just share a plurality of functions to be used for encryption, the order to apply the plurality of functions, and numbers to apply the functions, in advance. For example, the encryption devices 100 and 200 may just store rules indicating a plurality of the Cantor functions to be use for encryption, the inverse functions to be used for decryption, and the numbers to apply the functions, in advance, and notify by which rule encrypted information is transmitted/received. Further, for example, the encryption devices 100 and 200 may dynamically change the functions to be used for encryption and decryption, the order to apply the functions, and the numbers to apply the functions according to details of the plaintext as the transmission object, a bit number, date and time to perform transmission/reception, and the like. That is, the encryption devices 100 and 200 may execute the above-described encryption processing according to an arbitrary rule as long as the encryption devices 100 and 200 apply a plurality of functions in order having a quasi-periodic structure to encrypt the plaintext.

1-6. Examples of Mathematical Formulas

Next, an example of mathematical formulas to be used when the encryption device 100 performs the above-described encryption will be described. Note that the mathematical formulas described below are mere examples, and the encryption device 100 may use mathematical formulas in other formats as long as the encryption device 100 applies a plurality of functions in order of having the quasi-periodic structure.

1-6-1. Use of Mathematical Formula Indicating Electromagnetic Potential

First, as an example of the quasi-periodic structure, an example of using mathematical formulas indicating Aharonov-Bohm effect of when an electron is moved in a space in which regions having different electromagnetic potentials are arrayed according to the Fibonacci sequence will be described.

For example, the Schrodinger equation indicating a state of the electron can be expressed by the expression (1) below, where a wave function of the electron is φ (x). Here, φ in the expression (1) is a magnetic flux expressed by the expression (2).

$$\begin{matrix}\frac{1}{2 {m}^{*}} {( - i ℏ \frac{d}{dx} - e \frac{Φ}{2 a} )}^{2} φ ( x ) = E φ ( x ) & ( 1 ) \\ Φ ≡ f ( {Φ}_{0} / 2 π ) & ( 2 )\end{matrix}$$

Here, when the Aharonov-Bohm effect of the regions is illustrated by a diagram called AB ring, the Aharonov-Bohm effect of the entire region where the electron is moved can be schematically illustrated by arranging the AB rings corresponding to the regions according to the Fibonacci sequence as illustrated in FIG. 1. To be more specific, the encryption device 100 can apply the Aharonov-Bohm effect of when the electron is moved in the space where the regions having different electromagnetic potentials are arrayed according to the Fibonacci sequence, into the above-described encryption processing, by considering the function φa and the function φb as the magnetic fluxes φ of the regions. Note that, in the description below, the AB ring corresponding to the function φa is described as a unit α, and the AB ring corresponding to the function φb is described as a unit β. Note that the units α and β respectively correspond to regions having different magnetic fluxes from each other.

Here, a region where the electron is transmitted into the AB rings (a region on an incident side) is a first region, a region connecting an incident portion of the electron and an emission portion of the electron, of the AB rings, in a clockwise manner, is a second region, a region connecting the emission portion of the electron and the incident portion of the electron, of the AB rings, is a third region, and a region where the electron is emitted from the AB rings is a fourth region. Wave functions φ₁ to φ₄ can be expressed by the following expressions (3) to (6), where a wave function in the first region is φ₁, a wave function in the second region is φ₂, a wave function in the third region is φ₃, and a wave function in the fourth region is φ₄.

Here, t_{α} represents amplitude of the transmitted electron, r_{α} represents amplitude of a reflected electron, and C₂, D₂, C₃, and D₃ represent amplitude of the wave functions in the second region and the third region. Further, k represents a wavenumber of the electron having energy illustrated in the following expression (7).

φ₁(x₁)=e^{ikx}^{₁}+r_{α}e^{-ikx}^{₁} (3)

φ₂(x₂)=C₂e^{ik}^{₁}^{x}^{₂}+D₂e^{-ik}^{_{II}}^{x}^{₂} (4)

φ₃(x₃)=C₃e^{ik}^{_{II}}^{x}^{₃}+D₃e^{-ik}^{_{I}}^{x}^{₁} (5)

φ₄(x₄)=t_{α}e^{ikx}^{₄} (6)

E=h²k²/2m^{x} (7)

Further, k_{I} in the expression (4) and k_{II} in the expression (5) are values expressed by the following expressions (8) and (9).

k_{I}k+f/(2a) (8)

k_{II}=k−f/(2a) (9)

As a result, the amplitude t_{α} on the transmission side with respect to the unit α and the amplitude r_{α} on the opposite side can be expressed by the following expressions (10) and (11). Here, a in the expressions (10) and (11) is a semiperimeter of the AB ring. Further, Δₛ (k, f, a) in the expressions (10) and (11) can be expressed by the following expression (12).

$$\begin{matrix}{t}_{a} = \frac{16 i}{{Δ}_{s} ( k , f , a )} sin ka cos \frac{f}{2} & ( 10 ) \\ {r}_{a} = \frac{1}{{Δ}_{s} ( k , f , a )} ( 2 - 4 cos f - 3 cos 2 ka ) & ( 11 ) \\ {Δ}_{s} ( k , f , a ) ≡ 2 + 8 cos f - 9 {e}^{- 2 ika} - {e}^{2 ika} & ( 12 )\end{matrix}$$

As a result, a transfer matrix of the electron in the unit α can be expressed by the following expression (13). Further, a transfer matrix of the electron in the unit β can also be similarly obtained by the above-described expressions (3) to (13), using the value of the semiperimeter a of the AB ring as b.

$${M}_{a} = ( \begin{matrix}1 / {t}_{α}^{*} & - {r}_{α}^{*} / {t}_{α}^{*} \\ - {r}_{α} / {t}_{α} & 1 / {t}_{α}\end{matrix} ) \qquad ( 13 )$$

Here, when the units α and β are arranged in order of the Fibonacci sequence, the transfer matrix Mⱼ₊₁ of the (j+1)-th AB ring can be expressed by the following expression (14), where the transfer matrix of the (j−1)-th AB ring counted from the incident side is Mⱼ₋₁, and the transfer matrix of the j-th AB ring is Mⱼ. Here, M₀=M_{β} and M₁=M_{α} are established on the basis of the rule of the Fibonacci sequence. That is, the first AB ring is the unit α.

Mⱼ₋₁=MⱼMⱼ₋₁(j≧1) (14)

As a result, the entire transfer matrix of when N AB rings are arranged in order of the Fibonacci sequence can be expressed by the following expression (15).

$${M}_{N} = ( \begin{matrix}1 / {t}_{N}^{*} & - {r}_{N}^{*} / {t}_{N}^{*} \\ - {r}_{N} / {t}_{N} & 1 / {t}_{N}\end{matrix} ) \qquad ( 15 )$$

Here, t_{N} in the expression (15) represents amplitude of the electron transmitted in the entire region, and r_{N} represents amplitude of the electron reflected from the entire region. As a result, a probability that the entire regions transmit the electron, that is, a transmission probability can be expressed by the following formula (16).

T_{N}=t*_{N}t_{N}. (16)

Note that resistance of the entire region when the temperature is zero can be obtained by a Landauer formula expressed by the following expression (17).

G_{N}=(2e²/h)T_{N}. (17)

Note that the above expression (15) is the transfer matrix of the entire region of when the N AB rings are arranged in order of the Fibonacci sequence. Such a matrix can be considered as a matrix to be applied to the plaintext when the function φa (that is, corresponding to the unit α) and the function φb (that is, corresponding to the unit β) are arranged in order of the Fibonacci sequence. Further, the transmission probability expressed by the expression (16) can be considered as the ciphertext when the electron transmitted by the N AB rings is the plaintext.

Therefore, the encryption device 100 considers the plaintext as the electron entering the AB rings, and obtains the transmission probability illustrated by the expression (16), using the above expression (15), thereby to calculate the ciphertext that is the encrypted plaintext. To be specific, the encryption device 100 employs a bit string representing the plaintext as a wavenumber k of the electron. Further, the encryption device 100 sets values of f and a in the expressions (11) and (12) as parameters. For example, the encryption device 100 may just change the value of a in the expression (12) to b in the units α and β.

As a result, the encryption device 100 calculates a transmission probability T_{N} expressed by the expression (16) from the bit string of the plaintext, using the expression (15), and transmits a calculated value of the transmission probability T_{N} as the ciphertext. Note that the encryption device 200 may just calculate a value of the wavenumber k of the electron on the incident side, from the value of the transmission probability T_{N} expressed by the expression (16), using an inverse matrix of the transfer matrix expressed by the expression (15), and obtain the plaintext from the calculated value.

1-6-2. Use of Other Mathematical Formula

Here, as another example of the quasi-periodic structure, the encryption device 100 may use an expression representing a transmission probability of when a substance having a self-similar structure transmits the electron, or may use an expression representing a transmission probability of when a photon is moved in a crystal having a self-similar structure, other than the above-described expressions. For example, assume that two types of structures corresponding to T stubs such as a unit A and a unit B are arranged in order of the Fibonacci sequence, as the self-similar structure. In such a case, a transfer matrix Mₙ and αₙ and βₙ have the relationship of the expression (18) below, and the transfer matrix Mₙ can be expressed by the expression (19) below, where probability amplitude in an n-th stub on the transmission side is Aₙ and Bₙ, and Aₙαₙ+iβₙ and Bₙ=αₙ−iβₙ. Note that k in the expression (19) is the wavenumber of electron (that is, corresponding to the plaintext), lₙ represents a length of n-th segment, and Lₙ represents a length of the n-th stub.

$$\begin{matrix}( \begin{matrix}{α}_{n + 1} \\ {β}_{n + 1}\end{matrix} ) = {M}_{n} ( \begin{matrix}{α}_{n} \\ {β}_{n}\end{matrix} ) & ( 18 ) \\ {M}_{n} = ( \begin{matrix}1 & 0 \\ - cot ( {kL}_{n} ) & 1\end{matrix} ) ( \begin{matrix}cos ( {kl}_{n} ) & - sin ( {kl}_{n} ) \\ sin ( {kl}_{n} ) & cos ( {kl}_{n} )\end{matrix} ) & ( 19 )\end{matrix}$$

As a result, the transmission probability T_{N} can be expressed by the following expression (20).

$${T}_{N} = \frac{4}{{\vert {M}_{N} \vert}^{2} + {2}^{′}} \qquad ( 20 )$$

The encryption device 100 calculates the transmission probability expressed by the expression (20), using the transfer matrix expressed by the expression (19), and transmits the calculated transmission probability as the ciphertext. In this way, the encryption device 100 may perform encryption using mathematical formulas of an arbitrary phenomenon as long as the encryption device 100 performs encryption in which a plurality of functions is applied to the plaintext in order of having a quasi-periodic structure. That is, the encryption device 100 may apply a mathematical formula expressing the entire system to the plaintext to create the ciphertext without actually applying mathematical formulas corresponding to the regions to the plaintext as long as the encryption device 100 uses a mathematical formula expressing a transmission probability by which a transmission object transmits the entire system in a system in which regions having different variables regarding transmission are arranged in order of having a quasi-periodic structure.

Note that the encryption device 100 may just perform the encryption by storing the expressions (10) to (16) and the expressions (18) to (20) in advance, and applying the expressions (10) to (16) and the expressions (18) to (20), considering the plaintext as the wavenumber.

2. Configuration of Encryption Device

Hereinafter, an example of a functional configuration held by the encryption device 100 that realizes the above-described encryption processing will be described. FIG. 2 is a diagram illustrating a configuration example of an encryption device according to an embodiment. As illustrated in FIG. 2, the encryption device 100 includes a communication unit 20, a storage unit 30, and a control unit 40.

The communication unit 20 is realized by a network interface card (NIC), or the like. The communication unit 20 is then connected with the network N in a wired or wireless manner, and transmits/receives information to/from the encryption device 200 and the terminal device 300.

Here, the terminal device 300 is a smart device such as a smart phone or a tablet used by an arbitrary user, and is a mobile terminal device that can communicate with an arbitrary server device through a wireless communication network such as a 3rd generation (3G) network or a long term evolution (LTE) network. Note that terminal device 300 may be an information processing device such as a desktop PC or a note PC, other than the smart device.

The storage unit 30 is realized by a semiconductor memory device such as a random access memory (RAM) or a flash memory, or a storage device such as a hard disk or an optical disk. Further, the storage unit 30 stores a rule table 31.

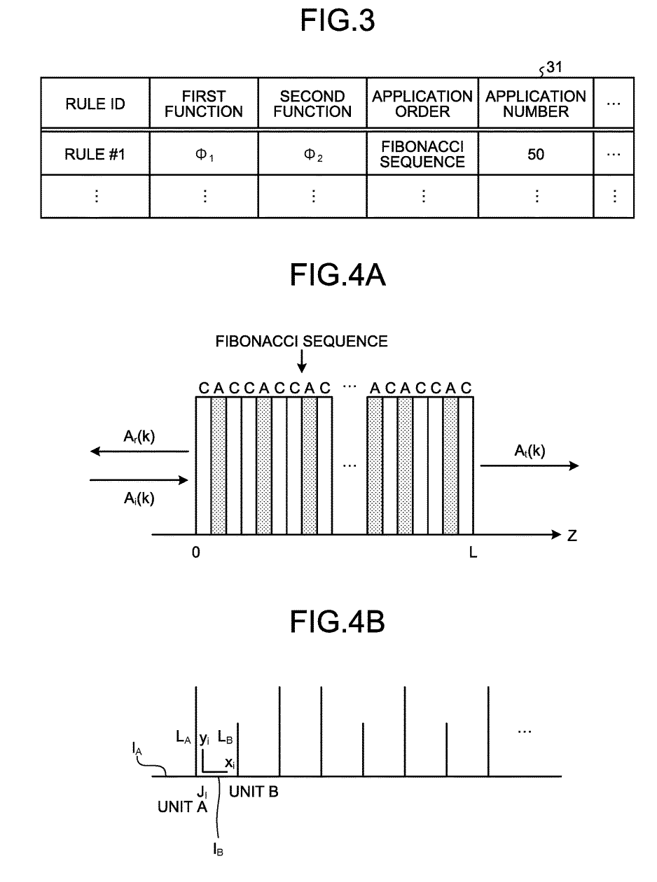

In the rule table 31, various rules to be used for encryption are registered. For example, FIG. 3 is a diagram illustrating an example of information registered in a rule table according to an embodiment. In the example illustrated in FIG. 3, in the rule table 31, information including items such as “rule ID”, “first function”, “second function”, “application order”, and “application number” is registered. Note that information other than the information illustrated in FIG. 3 may be registered to the rule table 31, such as the inverse functions to be used to decrypt the cipher, and the like.

Here, the “rule ID” is information for identifying a rule. The “first function” and the “second function” are functions to be applied to the plaintext. Further, the “application order” is information indicating the order to apply the “first function” and the “second function”. Further, the “application number” is information indicating how many of the associated “first function” and “second function” are applied.

For example, in the example illustrated in FIG. 3, the rule ID “rule #1”, the first function “φ₁”, the second function “φ₂”, the application order “Fibonacci sequence”, and the application number “50” are registered in association with one another. Such information indicates that the encryption is performed by applying the first function “φ₁” and the second function “φ₂” to the plaintext by “50” in order of the “Fibonacci sequence”.

Referring back to FIG. 2, and description is continued. The control unit 40 is a controller and is realized such that a processor such as a central processing unit (CPU) or a micro processing unit (MPU) executes various programs stored in a storage device inside the encryption device 100, using the RAM or the like as a work area. Further, the control unit 40 is a controller and may be realized by an integrated circuit such as an application specific integrated circuit (ASIC) or a field programmable gate array (FPGA).

As illustrated in FIG. 2, the control unit 40 includes an acquisition unit 41, an encryption unit 42, a transmission unit 43, a receiving unit 44, a decryption unit 45, and an output unit 46.

The acquisition unit 41 acquires information that is to be an encryption object, i.e., the plaintext. For example, when receiving the information that is to be a transmission object from the terminal device 300, the acquisition unit 41 outputs the received information to the encryption unit 42 as the plaintext.

The encryption unit 42 applies a plurality of functions to the acquired information in order of having a quasi-periodic structure to encrypt the information. To be more specific, the encryption unit 42 applies two different Cantor functions in order of the Fibonacci sequence to encrypt the plaintext. For example, the encryption unit 42 applies functions indicating crystal transmittances of light in a crystal in which regions having different transmittances are arranged in order of having a quasi-periodic structure, such as a photonic crystal to encrypt the plaintext.

For example, FIGS. 4A and 4B are diagrams illustrating an example of processing in which an encryption device according to an embodiment performs encryption. For example, the example illustrated in FIG. 4A illustrates, as an example of the quasi-periodic structure, a schematic diagram of a self-similar photonic crystal (hereinafter, may be described as “crystal”) in which regions C and regions A having different transmittances of a wave such as light are arranged according to the Fibonacci sequence.

Here, relationship of amplitude among an incident wave Aᵢ(k), a reflected wave Aᵣ(k), and a transmitted wave Aₜ(k) can be expressed by (At 0)=(Aᵢ Aᵣ)M_{A}⁽ⁿ⁾, where the wavenumber of a wave such as light entering the crystal is k, and the transfer matrix of the crystal is M_{A}⁽ⁿ⁾. Therefore, the encryption unit 42 considers the transfer matrix M_{A}⁽ⁿ⁾ of such a crystal as a key of encryption, considers the wavenumber of the incident wave Aᵢ(k) as the plaintext, and considers the wavenumber of the transmitted wave Aₜ(k) as the ciphertext, to realize encryption of the plaintext. Note that specific mathematical formulas used in such processing correspond to the above-described expressions (1) to (17).

Note that, when performing encryption corresponding to the system illustrated in FIG. 4A, the attacker needs to identify not only the transmittances in the regions but also how the regions are arranged and how many regions are arranged. As a specific example, the attacker needs to obtain the transfer matrix M_{A}⁽ⁿ⁾ from the wavenumber of the transmitted wave Aₜ(k). However, classical and quantum algorithms to efficiently solve such a question have not yet been found. Therefore, it can be said that, when performing encryption corresponding to the system illustrated in FIG. 4A, obtainment of the plaintext from the ciphertext within a significant time is sufficiently difficult even if not only classical calculation but also quantum calculation is performed. As a result, the encryption device 100 can improve the robustness of the encryption method.

Further, the example illustrated in FIG. 4B illustrates, as another example of the quasi-periodic structure, an example in which two types of structures corresponding to T stubs such as a unit A and a unit B are arranged in order of the Fibonacci sequence. In a case having such a structure, the transfer matrix Mn can be expressed by the expression (19), and the transmission probability T_{N} can be expressed by the expression (20). The encryption unit 42 uses the transfer matrix of the system having the structure illustrated in FIGS. 4A and 4B as the encryption key, the wavenumber of the wave entering the system as the plaintext, and the wavenumber of the transmission probability as the ciphertext, thereby to acquire a similar ciphertext to that of when a plurality of functions is applied to the plaintext in order of having a quasi-periodic structure.

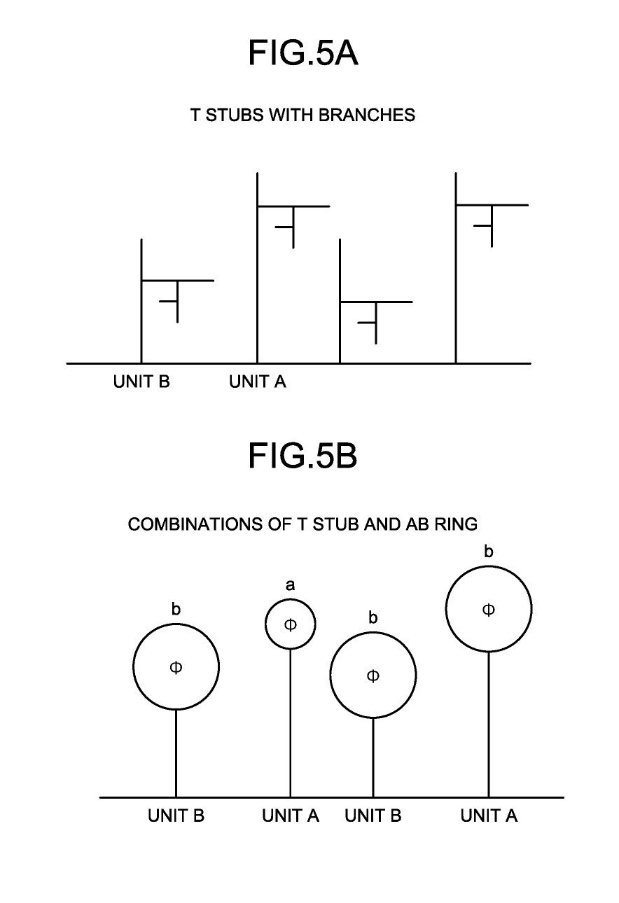

Note that the encryption unit 42 may perform encryption, using arbitrary quasi-periodic structure, other than the quasi-periodic structure illustrated in FIGS. 4A and 4B. For example, FIGS. 5A and 5B are diagrams illustrating variations of a quasi-periodic structure used by an encryption device according to an embodiment. For example, the encryption unit 42 may employ a structure in which T stubs branch, the T stubs being arranged in order of having a quasi-periodic structure, as illustrated in FIG. 5A. To be more specific, the encryption unit 42 may employ a structure in which the T stub is further attached to one T stub like a branch or a repeated structure in which the T stub is further attached to the T stub on the branch, like the unit A or the unit B.

Further, as illustrated in FIG. 4B, the encryption unit 42 may use a combination of the T stub and the AB ring. For example, the encryption unit 42 may employ a structure in which the T stubs such as the unit A and the unit B are arranged in order of having a quasi-periodic structure, and the AB ring corresponding to the unit α or the unit β is combined with each of the stubs to encrypt the plaintext. For example, in the example illustrated in FIG. 5B, the encryption unit 42 realizes the encryption by applying the functions to the plaintext in order of a combination of the T stub corresponding to the unit B and the AB ring corresponding to the unit β, a combination of the T stub corresponding to the unit A and the AB ring corresponding to the unit α, a combination of the T stub corresponding to the unit B and the AB ring corresponding to the unit β, and a combination of the T stub corresponding to the unit A and the AB ring corresponding to the unit β.

Referring back to FIG. 2, and description is continued. the transmission unit 43 transmits the information encrypted by the encryption unit 42, i.e., the ciphertext to the encryption device 200 as a destination. Note that the transmission unit 43 may perform communication with the encryption device 200 by an arbitrary communication method, such as quantum communication or encryption communication.

The receiving unit 44 receives the ciphertext encrypted by the encryption device 200. In such a case, the receiving unit 44 outputs the ciphertext to the decryption unit 45.

The decryption unit 45 decrypts the ciphertext encrypted by the encryption device 200. For example, the decryption unit 45 considers the ciphertext as the wavenumber of the transmitted wave, and applies the inverse matrix of the transfer matrix used for the encryption by the encryption device 200 to the ciphertext to obtain the plaintext. That is, the decryption unit 45 applies the inverse functions of the functions to the ciphertext in the reverse order to the order of when the encryption device 200 has applied the functions to the plaintext to decrypt the ciphertext.

The output unit 46 outputs the decrypted plaintext. For example, the output unit 46 transmits the plaintext decrypted by the decryption unit 45 to the terminal device 300.

Note that the encryption devices 100 and 200 share which rule, of the rules registered in the rule table 31, is to be used, before performing the encryption communication, for example. Then, the encryption device 100 may just perform the encryption and the decryption according to the shared rule.

Further, the encryption devices 100 and 200 may store, in advance, a matrix that realizes similar processing to the processing of when the functions are applied in order of a quasi-periodic structure, i.e., a transfer matrix serving as the Cantor functions, and share which Cantor function is to be used, before the encryption communication, instead of storing a plurality of functions as a rule.

3. Robustness of Ciphertext

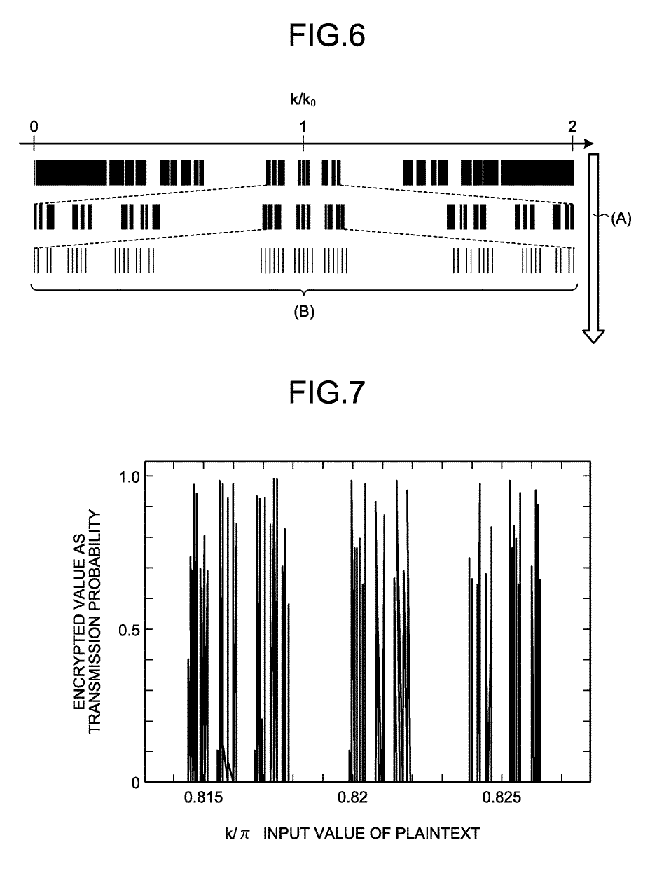

Here, the robustness of the ciphertext encrypted by the encryption method will be described using FIGS. 6 and 7. For example, FIG. 6 is a diagram illustrating an example of spectrum of a wavenumber of a wave that passes through a self-similar photonic crystal. The example illustrated in FIG. 6 illustrates an example of a spectrum held by a wavenumber of a wave that passes through a self-similar photonic crystal in which regions having different transmittances are arranged in order of the Fibonacci sequence, as illustrated in FIG. 4A.

For example, as illustrated in the top row in FIG. 6, the spectrum held by the wavenumber of the wave that passes through the self-similar photonic crystal seems to have continuity in a certain region. However, as illustrated in (A) in FIG. 6, when the regions are gradually enlarged and analyzed, the spectrum of the wavenumber is configured from discontinuous regions, as illustrated in (B) in FIG. 6. Therefore, the spectrum held by the wavenumber of the wave that passes through the self-similar photonic crystal as illustrated in FIG. 4A cannot be differentiated, and thus the wavenumber of the incident light cannot be calculated from the wavenumber of the transmitted light by differentiation or the like. Note that the technique of the present application may be applied by using a substance that configures a wave such as a semiconductor, a superconductive device, or a medium that transmit a sound wave is used, other than the photonic crystal, to configure a wave not having translational symmetry.

Further, FIG. 7 is a diagram illustrating an example of relationship between a transmission probability and a wavenumber. The example illustrated in FIG. 7 is a diagram in which the transmission probability of the system with respect to the incident light having the wavenumber k is plotted, where the wavenumber of incident light entering the system in which two types of AB rings as illustrated in FIG. 1 are arranged in order of the Fibonacci sequence is k, the horizontal axis direction represents a value obtained by dividing k by π, and the vertical axis direction represents the transmission probability. As illustrated in FIG. 7, it is apparent that the value of the transmission probability to the wavenumber k in the system in which the two types of AB rings are arranged in order of the Fibonacci sequence takes a discontinuous value. Therefore, in the system in which the two types of AB rings as illustrated in FIG. 1 are arranged in order of the Fibonacci sequence, the transmission probability cannot be calculated from the wavenumber of the transmitted light by differentiation or the like.

Therefore, the encryption device 100 uses the wavenumber of the incident light to the system as the plaintext, and the wavenumber or the transmission probability of the transmitted light as the ciphertext. Therefore, the attacker cannot calculate the plaintext by a technique using differentiation from the ciphertext encrypted by the above encryption method. Further, even if the attacker can acquire a set of the plaintext and the ciphertext, processing of generating the encryption key from the plaintext and the ciphertext is similarly difficult to the processing of calculating the energy spectrum of the system from the wavenumber of the incident light entering the various systems and the wavenumber of the transmitted wave. Calculation of the energy spectrum of a system having a quasi-periodic structure is sufficiently difficult. Therefore, the encryption device 100 can improve the robustness of the encryption method by the above-described encryption technique.

4. Example of Flow of Processing Executed by Encryption Device

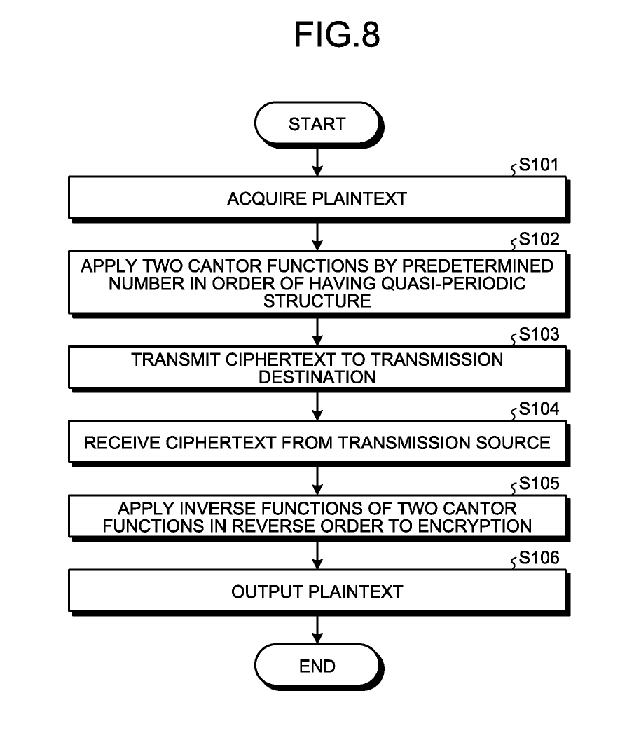

Next, an example a flow of the encryption processing executed by the encryption device 100 and a flow of the decryption processing executed by the encryption device 200 will be described using FIG. 8. FIG. 8 is a flowchart for describing an example of a flow of the encryption processing and the decryption processing according to an embodiment. First, the encryption device 100 acquires the plaintext as the encryption object (step S101). In such a case, the encryption device 100 applies two Cantor functions to the plaintext by a predetermined number in order of having a quasi-periodic structure (step S102) to generate the ciphertext. The encryption device 100 transmits the ciphertext to the encryption device 200 as a transmission destination (step S103).

In such a case, when receiving the ciphertext from the transmission source (step S104), the encryption device 200 applies the inverse functions of the two Cantor functions used by the encryption device 100 in step S102 in reverse order to the order in which the encryption device 100 has applied the corresponding Cantor functions to the plaintext (step S105) to decrypt the ciphertext. The encryption device 200 then outputs the decrypted plaintext (step S106), and terminates the processing. Note that the encryption device 200 may execute steps S101 to S103 when transmitting the information, and the encryption device 100 may execute steps S104 to S106 when receiving the information.

5. Modification

In the above description, an example of encryption processing by the encryption device 100 has been described. However, the embodiment is not limited thereto. Hereinafter, variations of encryption processing executed by the encryption device 100 will be described.

5-1. Device Configuration

In the above-described example, the encryption device 100 executes the encryption processing and the decryption processing in the encryption device 100. However, the embodiment is not limited thereto. For example, the encryption device 100 may be a device that includes only the acquisition unit 41, the encryption unit 42, and the transmission unit 43 illustrated in FIG. 2, and perform only encryption of a plaintext and transmission of a ciphertext. Further, another server that includes the receiving unit 44, the decryption unit 45, and the output unit 46 illustrated in FIG. 2 may be installed as a decryption device that decrypts the ciphertext, separately from the encryption device 100. Further, in a case where the encryption device 100 has only one rule of encryption, the encryption device 100 may not store the rule table 31. Further, the encryption device 100 may have the rule table 31 registered in an external storage server.

5-2. Others

Further, a part or all of the processing described as those automatically performed, of the processing described in the above embodiments, can be manually performed. Further, a part or all of the processing described as those manually performed can be automatically performed by a known method. In addition, the processing procedures, the specific names, and the information including the various data and parameters described and illustrated in the above writing and drawings can be arbitrarily changed unless otherwise specified. For example, the various types of information illustrated in the drawings are not limited to the illustrated information, for example.

Further, the illustrated configuration elements of the devices are functional conceptual elements, and are not necessarily physically configured as those illustrated in the drawings. That is, the specific forms of distribution and integration of the devices are not limited to those illustrated in the drawings, and a part or all of the forms can be functionally or physically distributed and integrated in arbitrary units according to various loads and usages. For example, the acquisition unit 41, the encryption unit 42, and the transmission unit 43 illustrated in FIG. 2 may be integrated.

Further, the above-described embodiments can be appropriately combined without contradicting the processing details.

6. Program

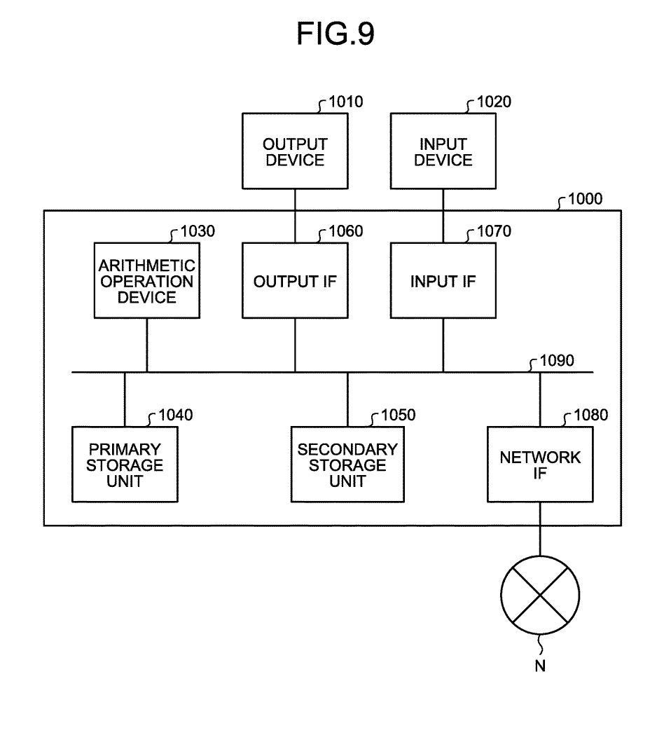

Further, the encryption device 100 according to the above-described embodiments is realized by a computer 1000 having a configuration as illustrated in FIG. 9. FIG. 9 is a diagram illustrating an example of a hardware configuration. The computer 1000 is connected with an output device 1010 and an input device 1020, and has a form in which an arithmetic operation device 1030, a primary storage device 1040, a secondary storage device 1050, an output interface (IF) 1060, an input IF 1070, and a network IF 1080 are connected by a bus 1090.

The arithmetic operation device 1030 is operated on the basis of programs stored in the primary storage device 1040 and the secondary storage device 1050, a program read from the input device 1020, and the like to execute various types of processing. The primary storage device 1040 is a memory device such as a RAM that primarily stores data to be used for various arithmetic operations by the arithmetic operation device 1030. Further, the secondary storage device 1050 is a storage device in which data to be used for various arithmetic operations by the arithmetic operation device 1030 and various databases are registered, and is realized by a read only memory (ROM), an HDD, a flash memory, or the like.

The output IF 1060 is an interface for transmitting information to be output to the output device 1010 such as a monitor and a printer that outputs various types of information, and is realized by a connector of a standard such as universal serial bus (USB), a digital visual interface (DVI), or high definition multimedia interface (HDMI (registered trademark)). Further, the input IF 1070 is an interface for receiving information from various input devices 1020 such as a mouse, a keyboard, and a scanner, and is realized by a USB, for example.

Note that the input device 1020 may be a device that reads information from an optical recording medium such as a compact disc (CD), a digital versatile disc (DVD), or a phase change rewritable disk (PD), a magneto-optical recording medium such as a magneto-optical disk (MO), a tape medium, a magnetic recording medium, or a semiconductor memory. Further, the input device 1020 may be an external storage medium such as a USB memory.

The network IF 1080 receives data from another device through the network N and sends the data to the arithmetic operation device 1030, or transmits data generated by the arithmetic operation device 1030 to another device through the network N.

The arithmetic operation device 1030 controls the output device 1010 and the input device 1020 through the output IF 1060 and the input IF 1070. For example, the arithmetic operation device 1030 loads the program from the input device 1020 or the secondary storage device 1050 onto the primary storage device 1040, and executes the loaded program.

For example, in a case where the computer 1000 functions as the encryption device 100, the arithmetic operation device 1030 of the computer 1000 executes the program loaded on the primary storage device 1040 to realize the function of the control unit 40.

7. Effects

As described above, the encryption device 100 acquires the information that is to be an encryption object and applies the plurality of functions to the information in order of having a quasi-periodic structure to encrypt the information. To be specific, the encryption device 100 applies the two different functions in order of the Fibonacci sequence to encrypt the information. For example, the encryption device 100 applies the function indicating the crystal transmittance in order of having a quasi-periodic structure to encrypt the information.

As a result, the encryption device 100 applies the functions that configures the function of the Cantor function as a whole to a plaintext, and thus can cause a ciphertext to have a characteristic called devil's staircase held by the Cantor function, that is, can make the ciphertext discontinuous. Therefore, the encryption device 100 can make an action to estimate an encryption key from the ciphertext by differentiation or the like sufficiently difficult, regardless of a classical calculation method and a quantum calculation method. As a result, the encryption device 100 can improve the robustness of the encryption method.

Further, the encryption device 100 can cause the question of generating an encryption key or a decryption key from a plaintext or a ciphertext to have a similar difficulty to the question of calculating an energy spectrum of a self-similar photonic crystal, thereby to improve the robustness of the encryption method.

Further, the above-described “section”, “module”, or “unit” can be rephrased as “means”, “circuit”, or the like. For example, “identifying unit” can be rephrased as “identifying means” or “identifying circuit”.

According to one aspect of an embodiment, the robustness of cipher can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An encryption device comprising:
an acquisition unit that acquire information that is to be an encryption object; and
an encryption unit that apply a plurality of functions to the acquired information in order of having a quasi-periodic structure to encrypt the information.

2. The encryption device according to claim 1, wherein
the encryption unit applies two different functions in order of Fibonacci sequence to encrypt the information.

3. The encryption device according to claim 1, wherein
the encryption unit applies functions indicating crystal transmittance in a predetermined crystal.

4. The encryption device according to claim 3, wherein
the encryption unit applies the functions indicating crystal transmittance in order of having a quasi-periodic structure to apply a function configuring a function of a Cantor function to the acquired information.

5. An encryption method executed by an encryption device, the encryption method comprising:
acquiring information that is to be an encryption object; and
encrypting the information by applying a plurality of functions to the acquired information in order of having a quasi-periodic structure.

6. An encryption data generated by an encryption method executed by an encryption device, the encryption method comprising:
acquiring information that is to be an encryption object; and
encrypting the information by applying a plurality of functions to the acquired information in order of having a quasi-periodic structure.

7. A non-transitory computer-readable recording medium having stored therein an encryption program that causes a computer to execute a process comprising:
acquiring information that is to be an encryption object; and
encrypting the information by applying a plurality of functions to the acquired information in order of having a quasi-periodic structure.
